(19) United States
(12) Patent Application Publication
(10) Pub. No.: US 2024/0327690 A1
(43) Pub. Date: Oct. 3, 2024

(54) SELF-CATALYZING SILICONE COMPOSITION, ADHESIVES FORMED THEREFROM, AND A METHOD OF MAKING SAME

(71) Applicant: MOMENTIVE PERFORMANCE MATERIALS INC., Niskayuna, NY (US)

(72) Inventors: Meenal Mehra, New Delhi (IN); Sandeep Naik, Maharashtra (IN); Tiberiu Mircea Siclovan, Rexford (NY); Arindam Sannigrahi, Bangalore (IN); Debarshi Dasgupta, Bangalore (IN); Praveen Mishra, Bangalore (IN); Sukanta Dolai, Bangalore (IN)

(21) Appl. No.: 18/128,662

(22) Filed: Mar. 30, 2023

(51) Int. Cl. C09J 183/02

(52) U.S. Cl. CPC C09J 183/02; C08G 77/70; C09J 2483/00

(57) ABSTRACT

A process for forming a silicone material is shown and described herein. The process comprises reacting (i) a MQ silicone resin, (ii) a polyorganosiloxane, and (iii) a hydrophilic functional siloxane, wherein the reaction is conducted in the absence of an external catalyst. The mixture of (i), (ii), and (iii) is self-catalyzing and does not require an external condensation catalyst. The process is suitable for forming a cured silicone material such as, for example, a pressure sensitive adhesive.

### FIELD OF INVENTION

The present invention relates to a silicone composition suitable for forming a silicone pressure sensitive adhesive and a method for making the same. In particular, the present invention relates to a composition that is free of an external catalyst, and may be considered self-catalyzing, and a method of making pressure sensitive adhesive materials from such compositions.

### BACKGROUND

Silicone pressure sensitive adhesives are an important class of adhesives used in a wide variety of applications. Silicone pressure sensitive adhesives are employed in high temperature, industrial, electronics, medical/healthcare, and drug delivery applications.

Many silicone pressure sensitive adhesives are produced by solution condensation of a branched silicone resin (an MQ resin) with a polydiorganosiloxane in the presence of a condensation catalyst. The reaction is conventionally carried out in a solvent, which is most often an aromatic solvent such as benzene, toluene, and/or xylene (BTX solvents) with subsequent curing via peroxide radicals. Another avenue for forming silicone pressure sensitive adhesives is addition curing of a vinyl containing siloxane polymer and a hydride containing siloxane oligomer using a platinum catalyst.

Solution condensation methods are generally the more preferred route in the industry to prepare silicone pressure sensitive adhesives. Solution condensation generally provides pressure sensitive adhesives with better adhesive properties and thermal performance compared to those prepared via the two-part addition curing methods. Additionally, most MQ resins are dispersed in a BTX (Benzene, Toluene, and Xylene) type solvent, thus making that process easier to use. There are some shortcomings with the condensation process such as coloring or haziness of the adhesive and salt formation/residual ionic content due to neutralization of the catalyst post condensation.

Other issues can arise from conventional methods due to residual catalysts that remain in the system after synthesis of the pressure sensitive adhesive. One issue is viscosity buildup over time that may occur due to ongoing condensation curing from catalyst that may remain in the system after synthesis. Viscosity buildup reduces processability and changes the physical properties of the PSA. Residual catalyst in the PSA after synthesis can also cause chain scission, which increases the cyclic content of the PSA and comprises the purity for some applications.

Neutralization of the catalyst is one way to remove the catalyst from the adhesive matrix. Neutralization results in precipitation of the salt and may cause coloration or deteriorate the optical clarity of the adhesive. Precipitates can also lead to the loss of adhesive properties of the PSA. Filtration of the precipitates often causes loss of material and an increase in the process cycle time.

Catalysts can also be deactivated using thermal deactivation. This requires high energy inputs to achieve and also increases the process cycle time.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a process for forming a pressure sensitive adhesive. The present process is a self-catalyzing reaction that is conducted without the aid of an external condensation catalyst, e.g., conventional metal or non-metal based catalysts. The reaction comprises reacting a silicone resin with a polyorganosiloxane and a siloxane comprising a hydrophilic group selected from an ionic group, an ionizable group, and/or a zwitterioinic group. The mixture of these materials has been found to provide a composition that can self-catalyze, which can be promoted by heating, to provide a cured material.

The absence of an external condensation catalyst provides a material that has low cyclic siloxane content, exhibits a good adhesive profile, and can have other desirable properties such as optical clarity (i.e., clear and colorless) and being odor free.

In one aspect, provided is a process for producing a pressure sensitive adhesive comprising: reacting (i) a MQ silicone resin, (ii) a polyorganosiloxane, and (iii) a siloxane comprising a hydrophilic group, wherein the reaction is conducted in the absence of an external catalyst.

In one embodiment, the hydrophilic functional group selected from an ionic group, an ionizable group, a zwitterionic group, or a combination of two or more thereof.

In one embodiment in accordance with any of the previous embodiments, the siloxane comprising a hydrophilic group (iii) is selected from a compound of the formula:

M¹ₐM²_{b}M³_{c}D¹_{d}D²ₑD³_{f}T¹_{g}T²ₕT³ᵢQ¹ⱼQ²ₖQ³ₗQ⁴ₒQ⁵ₚ
where
M¹=R⁵R⁶R⁷SiO_{1/2}
M²=R⁸R⁹R¹⁰SiO_{1/2}
M³=R¹¹R¹²R¹³SiO_{1/2}
D¹=R¹⁴R¹⁵SiO_{2/2}
D²=R¹⁶R¹⁷SiO_{2/2}
D³=R¹⁸R¹⁹SiO_{2/2}
T¹=R²⁰SiO_{3/2}
T²=R²¹SiO_{3/2}
T³=R²²SiO_{3/2}
Q¹=Si(OR²³)₁O_{3/2}
Q²=Si(OR²⁴)₂O_{2/2}
Q³=Si(OR²⁵)₃O_{1/2}
Q⁴=Si(OR²⁶)₄
Q⁵=SiO_{4/2}
where:
a, b, c, d, e, f, g, h, i, j, k, l, o, and p are zero or any positive integer subject to the following

$$1 \leq [ a + b + c + d + e + f + g + h + i + j + k + l + o + p ] \leq 6 \; 000 ; \\ [ b + e + h + k ] \geq 1 ;$$

R⁵, R⁶, R⁷, R⁹, R¹⁰, R¹², R¹³, R¹⁴, R¹⁵, R¹⁷, R¹⁹, and R²⁰ are each independently selected from hydrogen, a C1-C60 alkyl, a C6-C60 aromatic containing group, a C1-C10 alkoxy, and a hydroxyl;
R⁸, R¹⁶, R²¹, and R²⁴ are each independently selected from a monovalent hydrophilic group of the formula, where G≥0.

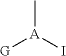

where A is a bridging unit between the siloxane moiety and the hydrophilic group I, having at least one spacing atom selected from a C1-C60 acyclic hydrocarbon radical, a C4-C60 alicylic radical, an C6-C60 aromatic hydrocarbon radical, a polyetheramine, a polyether, a polyamide, a polyester, a polyurethane, a polysulfone, a polycarbonate, or a combination of two or more thereof, where the bridging unit may include one or more moieties selected from alkoxy, carboxy, urethane, urea, ketone, or a combination of two or more thereof;
I is an ionic group, an ionizable group, a zwitterionic group, or a polar hydrophilic group or moieties including but not limited to a polyetheramine, a polyether, a polyamide, a polyester, a polyurethane, a polysulfone, or a polycarbonate;
G is a polymerizable group having the general Formula:

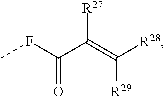

a non-polymerizable group of formula — —F-K, wherein F is a linker group chosen from a C1-C60 acyclic hydrocarbon radical, a C4-C60 alicylic radical, an C6-C60 aromatic hydrocarbon radical, a polyetheramine, a polyether, a polyamide, a polyester, a polyurethane, a polysulfone, a polycarbonate, or a combination of two or more thereof, where the bridging unit may include one or more moieties selected from alkoxy, carboxy, urethane, urea, ketone, or a combination of two or more thereof;
R²⁷, R²⁸, and R²⁹ are independently chosen from hydrogen or monovalent hydrocarbon radical with 1-5 carbon atoms, and
K is independently chosen from hydrogen, a C1-C60 acyclic hydrocarbon radical, a C4-C60 alicylic radical, an C6-C60 aromatic hydrocarbon radical, an epoxy, or an ether group;
R¹¹, R¹⁸, R²² are each independently selected from the group -A-G where A and G are as described above; and
R²³, R²⁵, and R²⁶ can be independently selected from R⁵ to R²² or a combination of thereof.

In one embodiment in accordance with any of the previous embodiments, the siloxane comprising a hydrophilic group is of the formula M¹ₐM²_{b}M³_{c}Q⁵ₚ, where b is ≥1.

In one embodiment in accordance with any of the previous embodiments, I is selected from a carboxylate —COO⁻, a dicarboxylate (—R(COO—)₂) a sulfone —SO₂—, a sulfonate —SO₃⁻, a sulfate —OSO₃⁻, a phosphonate —PO₃²⁻, a phosphate —OPO₃²⁻ group, —NR³⁰R³¹H, —NH₂R³², —NH₃, or an ammonium salt, each containing a hydrogen or a cation independently selected from an alkali metal, an alkali earth metal, a transition metal, a quaternary ammonium group, and a phosphonium group, where R³⁰, R³¹, and R³² are independently selected from a C1-C30 hydrocarbon

In one embodiment in accordance with any of the previous embodiments, I is selected from a group having the formula —R³³—N⁺(R³⁴)₂—R³⁵—I^{z}, where R³³ is a divalent hydrocarbon group having from 1 to 20 carbon atoms, R³⁴ is a monovalent hydrocarbon group having from 1 to 20 carbon atoms, R³⁵ is a divalent hydrocarbon group having from 2 to 20 carbon atoms; and P is an ionic group selected from a carboxylate —COO⁻, a sulfone —SO₂—, a sulfonate —SO₃⁻, a sulfate —OSO₃⁻, a phosphonate —PO₃²⁻, and a phosphate —OPO₃²⁻ group.

In one embodiment in accordance with any of the previous embodiments, I is a polar group selected from a polyetheramine, a polyether, a polyamide, a polyester, a polyurethane, a polysulfone, and/or a polycarbonate

In one embodiment in accordance with any of the previous embodiments, the hydrophilic group is a polyetheramine group selected from a compound of the formula

R³⁶—(O—R³⁷—)_{q}—NH₂
where R³⁶ is selected from a C1-C60 hydrocarbon, R³⁷ is selected from a C1-C60 hydrocarbon, and q is ≥1.

In one embodiment in accordance with any of the previous embodiments, the polyetheramine is selected from a compound of the formula:

R³⁶—(O—CH₂CH₂)ₓ—(O—C CH₂CH₂CH₂)_{y}—(O CH₂CH₂CH(CH₃))_{z}—NH₂
and x, y, and z are independently 0 to about 300, where x+y+z is ≥2.

In one embodiment in accordance with any of the previous embodiments, the polyetheramine group is selected by the following general formula:

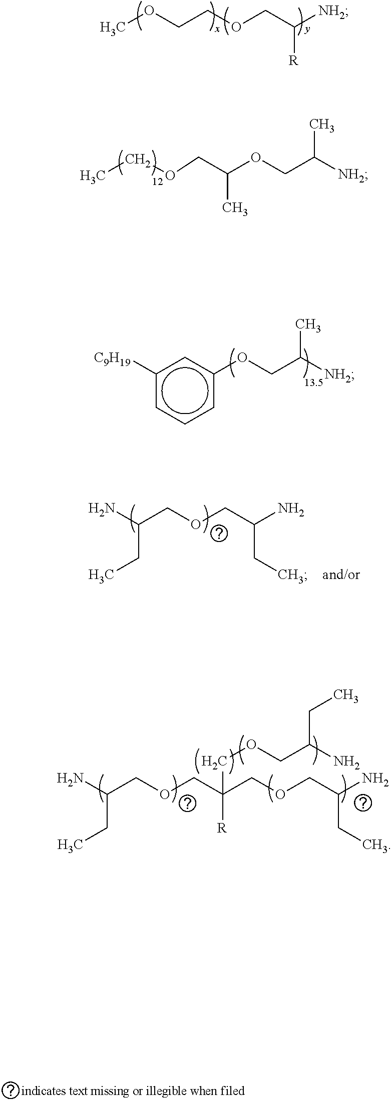

In one embodiment in accordance with any of the previous embodiments, the siloxane comprising a hydrophilic group (iii) is present in an amount of from about 0.1 wt. % to about 20 wt. % based on the total weight of the composition.

In one embodiment in accordance with any of the previous embodiments, the siloxane comprising a hydrophilic group (iii) is present in an amount of from about 1.5 wt. % to about 8 wt. % based on the total weight of the composition.

In one embodiment in accordance with any of the previous embodiments, reacting (i), (ii), and (iii) comprises forming a first mixture of (i) and (ii) and subsequently adding (iii) to the mixture of (i) and (ii).

In one embodiment in accordance with any of the previous embodiments, forming the first mixture of (i) and (ii) comprises dispersing the MQ silicone (i) in the polyorganosiloxane (ii), and heating the first mixture at temperature of from about 80 to about 150° C.

In one embodiment in accordance with any of the previous embodiments, reacting (i), (ii), and (iii) is carried out at a temperature of from about 80 to about 150° C.

In one embodiment in accordance with any of the previous embodiments, the process comprises removing water from the product obtained from the process to provide a solid mass.

In one embodiment in accordance with any of the previous embodiments, the process comprises dissolving the solid mass in a solvent to provide the final pressure sensitive adhesive composition.

In another aspect, provided is a pressure sensitive adhesive composition obtained from the process of any of the previous embodiments.

In one embodiment, the adhesive has a less than 2500 ppm of one or more of octamethylcyclotetrasiloxane, decamethylcyclopentasiloxane, and/or dodecamethylcyclohexasiloxane.

In one embodiment, the adhesive has a less than 1000 ppm of one or more of octamethylcyclotetrasiloxane, decamethylcyclopentasiloxane, and/or dodecamethylcyclohexasiloxane.

In one embodiment, the adhesive has a less than 500 ppm of one or more of octamethylcyclotetrasiloxane, decamethylcyclopentasiloxane, and/or dodecamethylcyclohexasiloxane.

In one embodiment, the adhesive has a less than 100 ppm of one or more of octamethylcyclotetrasiloxane, decamethylcyclopentasiloxane, and/or dodecamethylcyclohexasiloxane.

In one embodiment, the pressure sensitive adhesive does not exhibit precipitation after storage at room temperature for one year.

The following description discloses various illustrative aspects. Some improvements and novel aspects may be explicitly identified, while others may be apparent from the description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be appreciated that ranges for a particular component can be combined to form new and non-specified ranges.

As used herein, the term, “hydrocarbon radical” generically refers to acyclic, cyclic (or alicyclic), and aromatic hydrocarbons which can be saturated or unsaturated and which may be saturated or unsaturated and which may be optionally substituted or interrupted with one or more atoms or functional groups, such as, for example, carboxyl, cyano, hydroxy, halo and oxy. It will be appreciated that the term can encompass monovalent, divalent, and trivalent radicals, and that the appropriate type of radical is indicated and intended in the context of the bonding of such a radical within a given formula or structure.

As used herein, the term “acyclic hydrocarbon radical” means a straight chain or branched hydrocarbon radical, preferably containing from 1 to 60 carbon atoms per radical, which may be saturated or unsaturated and which may be optionally substituted or interrupted with one or more atoms or functional groups, such as, for example, carboxyl, cyano, hydroxy, halo and oxy. Suitable monovalent acyclic hydrocarbon radicals include, for example, alkyl, alkenyl, alkynyl, hydroxyalkyl, cyanoalkyl, carboxyalkyl, alkyloxy, oxaalkyl, alkylcarbonyloxaalkylene, carboxamide and haloalkyl, such as, for example, methyl, ethyl, sec-butyl, tert-butyl, octyl, decyl, dodecyl, cetyl, stearyl, ethenyl, propenyl, butynyl, hydroxypropyl, cyanoethyl, butoxy, 2,5,8-trioxadecanyl, carboxymethyl, chloromethyl and 3,3,3-fluoropropyl.

As used herein, the term “alicyclic hydrocarbon radical” means a radical containing one or more saturated hydrocarbon rings, preferably containing from 4 to 12 carbon atoms per ring, per radical which may optionally be substituted on one or more of the rings with one or more alkyl radicals, each preferably containing from 2 to 6 carbon atoms per alkyl radical, halo radicals or other functional groups and which, in the case of a monovalent alicyclic hydrocarbon radical containing two or more rings, may be fused rings. Suitable monovalent alicyclic hydrocarbon radicals include, for example, cyclohexyl and cyclooctyl.

As used herein, the term “aromatic hydrocarbon radical” means a hydrocarbon radical containing one or more aromatic rings per radical, which may, optionally, be substituted on the aromatic rings with one or more alkyl radicals, each preferably containing from 2 to 6 carbon atoms per alkyl radical, halo radicals or other functional groups and which, in the case of a monovalent aromatic hydrocarbon radical containing two or more rings, may be fused rings. Suitable monovalent aromatic hydrocarbon radicals include, for example, phenyl, tolyl, 2,4,6-trimethylphenyl, 1,2-isopropylmethylphenyl, 1-pentalenyl, naphthyl, anthryl. As used herein, the term “aralkyl” means an aromatic derivative of an alkyl group, preferably a (C2-C6)alkyl group, wherein the alkyl portion of the aromatic derivative may, optionally, be interrupted by an oxygen atom, such as, for example, phenylethyl, phenylpropyl, 2-(1-naphthyl)ethyl, preferably phenylpropyl, phenyoxypropyl, biphenyloxypropyl.

As used herein, viscosity may be evaluated using any suitable method. Unless indicated otherwise, viscosity is measured at 25° C. with a Brookfield (DV1) Viscometer.

Provided is a composition and process for producing a silicone-based material. The composition comprising a mixture of components for producing a silicone-based material, and comprises an ionic or zwitterionic functional siloxane component. The use of the ionic/zwitterionic functional siloxane has been found to provide a self-catalyzing activity such that an external catalyst is not needed to produce the silicone-based material. The process and composition can be utilized to provide a silicone-based material such as, for example, a silicone pressure sensitive adhesive. The resulting material produced from the composition and process may exhibit excellent properties and avoid issues surrounding the use of external catalysts including solution clarity, reduced viscosity build up, lower cyclic content, and others.

The present process comprises reacting a polyorganosiloxane and a silicone resin in the presence of a siloxane comprising a hydrophilic group selected from an ionic, an ionizable, and/or a zwitterioinic group. In one embodiment, a solid silicone resin (in the form of a MQ type resin) is dispersed in a polyorganosiloxane polymer and heated at a temperature of from about 40 to about 80° C., about 80 to about 150° C., from about 90 to about 125° C., or from about 100 to about 110° C. The siloxane comprising a hydrophilic group is added to the mixture of the polyorganosiloxane and the silicone resin and heated for a period of time sufficient for condensation to occur to a selected extent. In this process, no additional catalyst (e.g., metal catalysts such as, but not limited to, catalysts conventionally utilized in addition curing, condensation curing, and the like) is required to promote condensation to form the cured material.

It will be appreciated that condensation between the polyorganosiloxane and the silicone resin may also be referred to as “bodying”. As used herein, the terms “bodied” and “bodying” mean a condensation reaction between the functional hydroxyl groups of a silicone polymer and the functional hydroxyl groups of a silicone resin in order to increase molecular weight or crosslinking, or both.

The composition for forming the silicone material includes (i) a silicone resin; (ii) a polyorganosiloxane, and (iii) a siloxane comprising a hydrophilic group The composition is substantially free of or completely free of any external catalyst. As used herein, the composition is considered substantially free of an external catalyst where there is 0.1 wt. % or less, less than 0.01 wt. %, or less than 0.001 wt. % of catalyst based on the weight of the composition.

The composition includes a silicone resin (i). Silicone resins are typically referred to as MQ silicone resins or MQ resins comprising M units represented by the formula R³SiO_{1/2}, and Q units represented by the formula SiO_{4/2}, where R is generally selected from a C1 to C60 hydrocarbon. The hydrocarbon can be selected from an acyclic radical, an alicyclic radical, and an aromatic radical. In one embodiment, R is selected from a C1-C60 alkyl radical, a C2-C60 unsaturated radical, a C5-C60 cycloaliphatic radical, and a C6-C60 aromatic radical. In one embodiment, R is selected from a C1-C10 alkyl radical. In one embodiment, R is selected from methyl, ethyl, propyl, isopropyl, butyl, isobutyl, tert-butyl, pentyl, hexyl, heptyl, or octyl.

In one embodiment, each R group is independently selected from a C1-C6 monovalent hydrocarbon, a C5-C20 cycloaliphatic radical, a C2-C6 olefinic radical, and a C6-C20 aromatic radical. Examples of suitable C1-C6 monovalent hydrocarbon radicals include, but are not limited to, methyl, ethyl, propyl, isopropyl, butyl, isobutyl, tert-butyl, pentyl, isopentyl, and hexyl. Examples of suitable cycloaliphatic radicals include, but are not limited to, cyclopyentyl, cyclohyexyl, cycloheptyl, cyclooctyl, etc. Examples of suitable C2-C6 olefinic radicals include, but are not limited to, vinyl, allyl, etc. Examples of suitable aromatic radicals include, but are not limited to, phenyl. In one embodiment, from about 95 to 100% of the R groups are methyl. In one embodiment, substantially all the R groups are free of unsaturation. In one embodiment, the MQ resin has from 0 to 0.5 mole % of the R groups contain any unsaturation.

The MQ resin is primarily formed of such M and Q units but may contain some residual D units (R₂SiO_{2/2}) and T units (RSiO_{3/2}). The respective R groups can be the same or different within a given M, D, or T unit. Generally, the MQ resin contains less than 20 mole % of D and T units, less than 15 mole % of D and T units, less than 10 mole % of D and T units, less than 5 mole % of D and T units, even less than 1 mole % of D and T units.

The silicone resin may have a ratio of M to Q units of from about 0.2:1 to about 1.7:1, from about 0.4:1 to about 1.5:1, from about 0.6:1 to about 1.2:1, or from about 0.8:1 to about 1:1.

The silicone resin may include some residual, free silanol (Si—OH) groups. In one embodiment, the silicone resin may have a silanol content of from about 0.5 wt. % to about 12.0 wt. %, from about 0.75 wt. % to about 10 wt. %, from about 1 wt. % to about 7.5 wt. %, or from about 2.5 wt. % to about 5 wt. % based on the weight of the silicone resin.

The silicone resin can also be provided in any suitable form. In embodiments, the silicone resin can be provided as a solid, a liquid, a dispersion, or as solution in a solvent.

In embodiments, the silicone resin can have a viscosity of from about 1 cps to about 10000 cps, from about 10 cps to about 7500 cps, from about 25 cps to about 5000 cps, from about 50 cps to about 2500 cps, or from about 75 cps to about 1000 cps. In embodiments, the silicone resin can have a viscosity of from about 1 cps to about 100 cps, from about 100 to about 1000 cps, or from about 1000 to about 10000 cps. The viscosity of the silicone resin can be based on the silicone resin as a liquid; or in a dispersion or solution, where the solids content of the silicone resin in the dispersion or solution is from about 10% solids to about 98% solids. In one embodiment, the viscosity is based on solution with about 60% solids.

The silicone resin can be provided by a single type of silicone resin or a mixture of two or more different types of resin. The different resins can differ in terms of structure, viscosity, molecular weight, ratio of M to Q units, and the like.

MQ resin materials are generally provided or obtained in a volatile solvent such as aromatic, e.g., BTX type, solvents. The solvent can be removed in any suitable manner. In one embodiment, the solventless MQ resin can be provided by removing the solvent via an extrusion process. Such a process is described in U.S. Pat. No. 8,017,712, which is incorporated herein by reference in its entirety. In another embodiment, the solventless MQ resin can be provided by removing the solvent via a spray drying process. as described in U.S. Pat. No. 5,324,806.

The polyorganosiloxane (ii) is selected from a silanol terminated polyorganosiloxane. In one embodiment, the polyorganosiloxane (ii) is a silanol terminated compound having the formula:

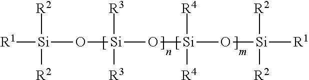

where R¹ is hydroxy (—OH) and R², R³, and R⁴ are independently selected from a C1-C60 hydrocarbon that may optionally be substituted with one or more halogen atoms, and n+m≥50 at 25° C.

In one embodiment, R², R³, and R⁴ are independently selected from a C1-C60 alkyl, a C1-C60 fluoroalkyl, a C2-C60 alkenyl, a C6-C60 aromatic containing group, phenyl, aryl, arylalkyl, fluoroalkyl groups, or a combination of two or more thereof. The aromatic containing compounds can include alkyaryl groups, arylalkyl groups, groups containing two or more aromatic rings, which can be separated by a bond, a linker group, or may be fused. In one embodiment, R², R³, and R⁴ are independently selected from a C1-C10 alkyl, a C6-30 aromatic containing, or a combination of two or more thereof. In one embodiment, R² is selected from a C1-C10 alkyl, R³ is selected from a C1-C10 alkyl, and R⁴ is selected from a C6-C30 aromatic group. In one embodiment, R², R³, and R⁴ are each methyl. In one embodiment, R² and R³ are methyl, and R⁴ is phenyl.

The polyorganosiloxane (ii) may have a viscosity of from 300 to 200,000,000, from about 500 to about 150,000,000, from about 1,000 to about 100,000,000, from about 2,500 to about 75,000,000, from about 5,000 to about 50,000,000, from about 10,000 to about 25,000,000, from about 20,000 to about 10,000,000, from about 30,000 to about 5,000,000, from about 50,000 to about 1,000,000, from about 75,000 to about 750,000, from about 100,000 to about 500,000, or from about 250,000 to about 400,000 centipoise (cps) at 25° C. and preferably The viscosity of polyorganosiloxane (ii) can be readily measured employing known and conventional viscosity measurement apparatus and techniques.

In one embodiment, the polyorganosiloxane (ii) has a viscosity of from about 50,000 to about 750,000, from about 75,000 to about 500,000, from about 100,000 to about 400,000, or from about 200,000 to about 300,000 cps.

It will be appreciated that the polyorganosiloxane (ii) can be provided as a mixture of two or more different polyorganosiloxane compounds. The different polyorganosiloxane can differ from one another in terms of structure, viscosity, size, and the like. In one embodiment, the polyorganosiloxane (ii) comprises a mixture of a first polyorganosiloxane having alkyl groups, and a second polyorganosiloxane comprising alkyl and aromatic groups. In one embodiment, the polyorganosiloxane (ii) comprises a first polyorganosiloxane having a first viscosity, and a second polyorganosiloxane having a second viscosity. In one embodiment, the first polyorganosiloxane has a viscosity of greater than 15,000 cPs, and the second polyorganosiloxane has a viscosity less than 12,000 cPs. In one embodiment the first polyorganosiloxane has a viscosity of from about 15,000 cPs to about 1,000,000 cPs, from about 25,000 cPs to about 750,000 cPs, from about 50,000 cPs to about 500,000 cPs, or from about 75,000 cPs to about 250,000 cPs; and the second polyorganosiloxane has a viscosity of from about 500 cPs to about 12,000 cPs, from about 1,000 cPs to about 10,000 cPs, from about 2,500 cPs to about 7,500 cPs, or from about 3,000 cPs to about 5,000 cPs.

The silicone resin (i) can be present in an amount of from about 40 wt. % to about 70 wt. %, from about 45 wt. % to about 65 wt. %, or from about 50 wt. % to about 55 wt. % based on the total weight of the silicone resin (i) and the polyorganosiloxane (ii). The polyorganosiloxane (ii) can be present in an amount of from about 30 wt. % to about 60 wt. %, from about 35 wt. % to about 55 wt. %, or from about 45 wt. % to about 50 wt. % based on the total weight of the silicone resin (i) and the polyorganosiloxane (ii).

The composition comprises a siloxane comprising a hydrophilic group. The siloxane comprising a hydrophilic group can be selected from a hydrophilic functional silicone resin (e.g., a MQ type resin) and/or a hydrophilic functional polyorganosiloxane. The hydrophilic functional group is selected from an ionic group, an ionizable group, or a zwitterionic functional group.

As used herein, an ionizable group refers to a group that is capable of forming an ionic group.

In one embodiment, the functionalized siloxane is a compound of the formula:

M¹ₐM²_{b}M³_{c}D¹_{d}D²ₑD³_{f}T¹_{g}T²ₕT³ᵢQ¹ⱼQ²ₖQ³ₗQ⁴ₒQ⁵ₚ
where
   M¹=R⁵R⁶R⁷SiO_{1/2}
   M²=R⁸R⁹R¹⁰SiO_{1/2}
   M³=R¹¹R¹²R¹³SiO_{1/2}
   D¹=R¹⁴R¹⁵SiO_{2/2}
   D²=R¹⁶R¹⁷SiO_{2/2}
   D³=R¹⁸R¹⁹SiO_{2/2}
   T¹=R²⁰SiO_{3/2}
   T²=R²¹SiO_{3/2}
   T³=R²²SiO_{3/2}
   Q¹=Si(OR²³)₁O_{3/2}
   Q²=Si(OR²⁴)₂O_{2/2}
   Q³=Si(OR²⁵)₃O_{1/2}
   Q⁴=Si(OR²⁶)₄
   Q⁵=SiO_{4/2}
   where:
a, b, c, d, e, f, g, h, i, j, k, l, o, and p are each independently selected from zero or any positive integer subject to the following limitations:

$$1 \leq [ a + b + c + d + e + f + g + h + i + j + k + l + o + p ] \leq 6 \; 000 ; \\ [ b + e + h + k ] \geq 1 ;$$

R⁵, R⁶, R⁷, R⁹, R¹⁰, R¹², R¹³, R¹⁴, R¹⁵, R¹⁷, R¹⁹, and R²⁰ are each independently selected from hydrogen, a C1-C60 alkyl, a C6-C60 aromatic containing group, a C1-C10 alkoxy, and a hydroxyl;
R⁸, R¹⁶, R²¹, and R²⁴ are each independently selected from a monovalent hydrophilic group of the formula, where G≥0:

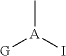

where A is a bridging unit between the siloxane moiety and the hydrophilic group I, having at least one spacing atom selected from a C1-C60 acyclic hydrocarbon radical, a C4-C60 alicylic radical, an C6-C60 aromatic hydrocarbon radical, a a polyetheramine, a polyether, a polyamide, a polyester, a polyurethane, a polysulfone, a polycarbonate, or a combination of two or more thereof, where the bridging unit may include one or more moieties selected from alkoxy, carboxy, urethane, urea, ketone, or a combination of two or more thereof;
I is an ionic, ionizable, zwitterionic group, or a polar hydrophilic group or moieties;
G is a polymerizable group having the general Formula:

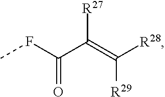

a non-polymerizable group of formula — —F-K, wherein F is a linker group chosen from a C1-C60 acyclic hydrocarbon radical, a C4-C60 alicylic radical, an C6-C60 aromatic hydrocarbon radical, a polyetheramine, a polyether, a polyamide, a polyester, a polyurethane, a polysulfone, a polycarbonate, or a combination of two or more thereof, where the bridging unit may include one or more moieties selected from alkoxy, carboxy, urethane, urea, ketone, or a combination of two or more thereof,
R²⁷, R²⁸, and R²⁹ are independently chosen from hydrogen or monovalent hydrocarbon radical with 1-5 carbon atoms, and
K is independently chosen from hydrogen, a C1-C60 acyclic hydrocarbon radical, a C4-C60 alicylic radical, an C6-C60 aromatic hydrocarbon radical, an epoxy, or an ether group;
R¹¹, R¹⁸, R²² are each independently selected from the group -A-G where A and G are as described above; and
R²³, R²⁵, and R²⁶ can be independently selected from R⁵ to R²² or a combination of thereof.

In one embodiment, A is a C1-C10 alkyl, a C1-C10 cycloalkyl, or a C6-C12 aromatic group. In one embodiment, A is a C1-C4 alkyl. It will be appreciated that the radical A will be divalent or trivalent depending on whether G is 0 or 1.

Where I is an ionic or ionizable group, I can be selected from an acid or base comprising a carboxylate —COO⁻, a dicarboxylate (—R(COO—)₂) a sulfone —SO₂—, a sulfonate SO₃⁻, a sulfate —OSO₃⁻, a phosphonate —PO₃²⁻, a phosphate —OPO₃²⁻ group, —NR³⁰R³¹H, —NH₂R³², —NH₃, or an ammonium salt, each containing a hydrogen or a cation independently selected from an alkali metal, an alkali earth metal, a transition metal, a quaternary ammonium group, and a phosphonium group, where R³⁰, R³¹, and R³² are independently selected from a C1-C30 hydrocarbon.

Where I is a zwitterionic moiety, the zwitterionic moiety is selected from a group comprising an anionic group and a cationic group in a covalently bonded compound and having a net neutral charge. In one embodiment, the zwitterionic group is selected from a group having the formula —R³³—N⁺(R³⁴)₂—R³⁵—I^{z} where R³³ is a divalent hydrocarbon group having from 1 to 20 carbon atoms, R³⁴ is a monovalent hydrocarbon group having from 1 to 20 carbon atoms, R³⁵ is a divalent hydrocarbon group having from 2 to 20 carbon atoms; and I^{z} is an ionic group selected from a carboxylate —COO⁻, a sulfone —SO₂—, a sulfonate —SO₃⁻, a sulfate —OSO₃⁻, a phosphonate —PO₃²⁻, and a phosphate —OPO₃²⁻ group.

In one embodiment, I is a polar group or moiety. The polar group or moiety refers to a group that is not ionizable or ionic in nature but contains heteroatoms that render the group polar. Without being bound to any particular theory, the polar groups may act as hydrogen bond acceptor, and those having hydrogen atoms directly bonded to a heteroatom may additionally act as hydrogen bond donors. Examples of suitable polar groups or moieties include, but are not limited to, a polyetheramine, a polyether, a polyamide, a polyester, a polyurethane, a polysulfone, and/or a polycarbonate.

In one embodiment, the hydrophilic group is selected from a polyetheramine. The polyetheramine can be selected from a compound containing an amine group and at least one polyalkylene oxide group. In one embodiment, the polyetheramine is selected from a compound of the formula:

R³⁶—(O—R³⁷—)_{q}—NH₂
where R³⁶ is selected from a C1-C60 hydrocarbon, R³⁷ is selected from a C1-C60 hydrocarbon, and q is ≥1. In one embodiment, R³⁶ and R³⁷ are independently selected from a C1-C60 alkyl, a C4-C30 cycloalkyl, and a C6-C30 aromatic group, where R³⁶ and R³⁷ can optionally include an amine functional group. In one embodiment, R³⁶ and R³⁷ are independently selected from a C1-C10 alkyl, a C4-C10 cycloalkyl, and a C6-C20 aromatic group, where R³⁶ and R³⁷ can optionally include an amine functional group. In one embodiment, q is 1 to about 200, about 4 to about 100, about 10 to about 50, or about 20 to about 40. In one embodiment, q is from 2 to about 40, about 4 to about 30, about 6 to about 25, about 8 to about 20, or about 10 to about 15.

In one embodiment, the polyetheramine is selected from a compound of the formula:

R³⁶—(O—CH₂CH₂)ₓ—(O—C CH₂CH₂CH₂)_{y}—(O CH₂CH₂CH(CH₃))_{z}—NH₂
where R36 is as described above, and x, y, and z are independently 0 to about 300, where x+y+z is ≥2.

Some examples of suitable polyetheramines include, but are not limited to:

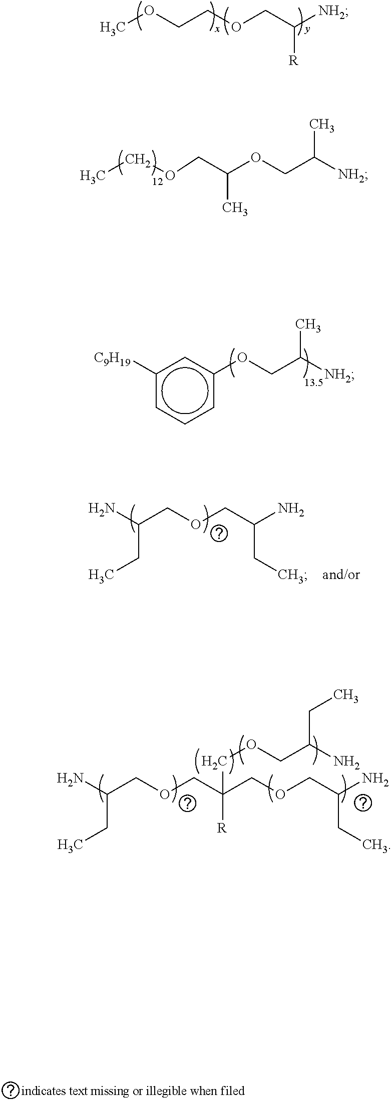

In one embodiment, the siloxane comprising a hydrophilic group (iii) is selected from a MD type polyorganosiloxane. In one embodiment, the functionalized siloxane (iii) is selected from a MQ type silicone resin comprising one or more M² groups with a hydrophilic functional group as described above. In an embodiment where the functionalized siloxane (iii) is a MQ type resin, the hydrophilic siloxane can be of the formula M¹ₐM²_{b}M³_{c}Q⁵ₚ, where b is ≥1.

The siloxane comprising a hydrophilic group (iii) can be a solid, a liquid, a dispersion, or solution in a solvent.

The siloxane comprising a hydrophilic group (iii), in embodiments, can have a viscosity of from 1 cps to about 10000 cps, from about 10 cps to about 7500 cps, from about 25 cps to about 5000 cps, from about 50 cps to about 2500 cps, or from about 75 cps to about 1000 cps. The siloxane comprising a hydrophilic group (iii), in embodiments, can have a viscosity of from about 1 cPs to about 100 cPs, from about 100 cPs to about 1000 cPs, or from about 1000 cPs to about 10000 cPs. The viscosity of the siloxane comprising a hydrophilic group can be based on the siloxane as a liquid; or in a dispersion or in solution, where the solids content of the siloxane comprising a hydrophilic group in the dispersion or solution is from about 10% solids to about 98% solids. In one embodiment, the viscosity is based on siloxane as a liquid.

The siloxane comprising a hydrophilic group (iii) can be present in an amount of from about 0.1 wt. % to about 20 wt. %, from about 0.5 wt. % to about 15 wt. % from about 1 wt. % to about 10 wt. %, from about 2 wt. % to about 8 wt. %, or from about 3 wt. % to about 5 wt. % based on the total weight of the composition.

The siloxane comprising a hydrophilic group are prepared by the reaction of an olefin bearing at least one polar group, and a silyl hydride in presence of a hydrosilylation catalyst.

The silyl hydride is chosen from a silicon containing compound comprising at least one —SiH group. The —SiH group can be part of a M, D, or T unit of the siloxane. In one embodiment, a silyl hydride is selected where —SiH is part of M units bonded to Q unit. As used herein, M represents a monofunctional group of formula R3SiO1/2, D represents a difunctional group of formula R²SiO2/2, T represents a trifunctional group of formula RSiO3/2, Q represents a tetrafunctional group of formula SiO4/2.

Some non-limiting examples of silyl hydrides include, Pentamethyldisiloxane such as P1535, tetramethyldisiloxane such as T1437, heptamethyltrisiloxane such as H1267, Tris(trimethylsiloxy)silane such as T3520 available from TCI; polymethylhydrosiloxane include HMS-082, HMS 501 HPM-502, 65 HMS-992, HMS-064, available from Gelest; polyhydrosilsesquioxane, octakis(dimethylsiloxy)-T8-silsesquioxane such as SIO6696.5 from Gelest, and other hydride-containing copolymers or homopolymers of dimethyl siloxane or phenyl-containing siloxanes such as HDP-111-hydride terminated poly- 15 phenyl(dimethylhydrosiloxy)siloxane, available from Gelest.

Other examples of silyl hydride agents include, but are not limited to, a Q resin, which may also be referred to as MQ hydride or hydride modified silica Q resins. These silyl hydrides have an activity of 1-25 equivalents/kg. Examples of those compounds include, but are not limited to, those commercially available under the tradename MQH-9 (Milliken & Company), which is a hydride-modified silica Q resin characterized by a molecular weight of 900 g/mole and an activity of 9.5 equivalents/kg; HQM 105 (Gelest, Inc.), which is a hydride modified silica Q resin characterized by a molecular weight of 500 g/mole and an activity of 8-9 equivalents/kg; and HQM 107 (Gelest, Inc), which is a hydride-modified silica Q resin characterized by a molecular weight of 900 g/mole and an activity of 8-9 equivalents/kg.

The solids content of the resulting pressure sensitive adhesive can be adjusted as desired with an appropriate solvent. The solids content of the pressure sensitive adhesive can be selected as desired for a particular purpose or intended application. In one embodiment, the solids content of the pressure sensitive can be adjusted to be from about 30% to about 80%, from about 40% to about 70%, or from about 50% to about 60%. The solvent is preferably a non-aromatic solvent and, more preferably a solvent other than a BTX (benzene, toluene, xylene) type solvent. Examples of suitable solvents that may be used to dissolve the pressure sensitive adhesive include, but are not limited to, hydrocarbon solvents, silicone solvents, an amide, an ester, a ketone, an alcohol, or an ether. The solvent can be a natural or synthetic material.

Examples of suitable aliphatic hydrocarbons include linear, branched, or cyclic aliphatic hydrocarbons having 6 to 16 carbon atoms, for example saturated acyclic aliphatic hydrocarbons (paraffins) such as heptane, hexane, octane, isooctane, decane, dodecane, and their isomers such as, but not limited to, isodecane, isohexadecane, dodecene, or isododecane, and cyclic aliphatic hydrocarbons such as, but not limited to, cyclohexane, methylcyclohexane or decahydronaphthalene. The aliphatic hydrocarbon solvent can be an alkene, for example heptene, cyclohexadiene, cyclohexene, or 2,5-dimethyl-2,4-hexadiene. Mixtures of aliphatic hydrocarbons are also suitable, for example the mixture of branched paraffins sold under the trademark ISOPAR®. Other suitable materials include natural terpenes such as, but not limited to pinene isomers, myrcene, bisabolnee, cadinene, and the like.

Examples of suitable volatile silicone solvents include, but are not limited to, linear, branched, and cyclic polydiorganosiloxanes, for example polydimethylsiloxanes such as linear trimethylsilyl-terminated polydimethylsiloxanes having a viscosity of 0.65 to 5 cP at 25° C., and cyclic polydimethylsiloxanes such as decamethylcyclopentasiloxane and octamethylcyclotetrasiloxane. Volatile silicone solvents can contain organic groups other than methyl, for example higher alkyl groups or phenyl groups. An example is 3-octyl heptamethyl trisiloxane. In one embodiment, viscosity is determined by dissolving the melt obtained PSA into a suitable solvent at 60% solids and measuring the viscosity at 25° C. with a Brookfield (DV1) Viscometer.

Examples of suitable ester solvents include, but are not limited to, carboxylate esters such as alkyl carboxylate esters and carbonate esters such as alkyl carbonate esters. For example the volatile solvent can comprise at least one C1-C8 alkyl ester of a C2-C4 carboxylic acid such as ethyl acetate or butyl acetate. Examples of suitable carbonate ester solvents include, but are not limited to, diethyl carbonate and dicaprylyl carbonate.

Examples of suitable ketone solvents include, but are not limited to, methyl isobutyl ketone (4-methyl-2-pentanone), 2-pentanone, 3-hexanone, methyl isoamyl ketone (5-methyl-2-hexanone), camphor, menthone, carvone, pulegone, and the like.

Examples of suitable ether solvents include, but are not limited to, dibutyl ether, volatile polyethers such as 1-(propoxymethoxy)propane and cyclic ethers such as cyclopentamethyl ether.

Examples of suitable alcohol solvents include, but are not limited to methanol, ethanol, propanol, butanol, cis-3-hexanol, trans-2, cis-6-nonadienol, cis-6-noneol, linalool, geraniol, nerol, citronellol, nerolidol, farnesol, benzyl alcohol, phenylethyl alcohol, cinnamic alcohol, citronellol, hydroxycitronellol, linalool, dihydrolinalool, tetrahydrolinalool, ethyllinalool, geraniol, nerol, tetrabydrogeraniol, nmyrcenol, dihydronmyrcenol, tetrahydromyreenol, ocinenol, terpineol, rnenthol, borneol, fenchyl alcohol, farnesol, nerolidol, cedrol, and terpineol, and the like.

The silicone pressure sensitive adhesives prepared by the method of this invention will readily stick to support a solid support or substrate, whether flexible or rigid. These pressure sensitive adhesive compositions may be applied to a surface by any suitable means such as rolling, spreading or spraying. The surface of the support and the substrate to which the support is adhered may be any known solid material such as metals, paper, wood, leather, fabrics, organic polymeric materials, painted surfaces, siliceous materials such as concrete, bricks, cinderblocks, and glass including glass cloth. After applying it to the surface, the adhesive may be cured by air drying or heating for example at temperatures of up to 300° C.

Additionally, the pressure sensitive adhesives produced by the present technology may exhibit a low concentration of cyclic siloxanes. In embodiments, the pressure sensitive adhesive contains less than about 2500 ppm, less than 2000 ppm, less than 1800 ppm, less than 1500 ppm, less than 1250 ppm, less than 1000 ppm less than 750 ppm, less than 500 ppm, less than 250 ppm, even less than 100 ppm of one or more of a octamethylcyclotetrasiloxane (D4), decamethylcyclopentasiloxane (D5), or dodecamethylcyclohexasiloxane (D6). In one embodiment, the pressure sensitive adhesive contains each of a D4, D5, or D6 cyclic siloxane in an amount of less than 2500 ppm, less than 2000 ppm, less than 1800 ppm, less than 1500 ppm, less than 1250 ppm, less than 1000 ppm less than 750 ppm, less than 500 ppm, less than 250 ppm, even less than 100 ppm.

In one embodiment, the pressure sensitive adhesive composition does not exhibit precipitation after storage at room temperature for one year. In pressure sensitive adhesives made using external catalysts, precipitation may occur due to ineffective neutralization of catalyst post condensation and their subsequent filtration. In aspects of the present technology, the pressure sensitive adhesive does not exhibit precipitation after storage at room temperature for a year. That is, the pressure sensitive adhesive composition may remain homogenous after storage at room temperature for one year.

The present technology has been described in the foregoing detailed description and with reference to various aspects and embodiments. The technology may be further understood with reference to the following Examples. The Examples are intended to further illustrate aspects and embodiments of the present technology and not necessarily to be limited to such aspects or embodiments.

### EXAMPLES

### MQ Silicone Resin

The solid MQ silicone resin used to prepare PSA. The solid MQ silicone resins which were used to prepare the pressure sensitive adhesives have a silanol content of 95473 ppm to 47746 ppm. The MQ resins employed are referred as MQ1-(silanol content of 95473 ppm), MQ2 (silanol content of 47746 ppm), MQ3 (silanol content of 56642 ppm), and MQ4 (silanol content of 80722 ppm) resin

### Polyorganosiloxane Gum

### Component 1-3

Components 1,2 and 3 illustrate the Polyorganosiloxane gum in accordance with aspects and embodiments of the present methods and their properties like molecular weight (MW) and cyclic content.

MW of components, examples and comparative examples was determined by Gel Permeation Chromatography (GPC) using Chloroform solvent and calibrated using polystyrene standards. The viscosity of components, examples and comparative examples was determined at 25° C. with a Brookfield (DV1) Viscometer using spindle #2 to #6. Cyclic content of components, examples and comparative examples was quantified using gas chromatographic method.

The Polyorganosiloxane gum of Component 1 to 3 is listed in Table 1 below:

TABLE 1
Polyorganosiloxane gum

| | | | | | Octamethyl |
|---|---|---|---|---|---|
| | | | | | cyclotetrasiloxanes |
| | | | Viscosity | MW | (D4) |
| Component | Description | CAS# | (cPs) | (g/mol) | Wt. % |
| 1 | Polyorganosiloxane | 556-67-2 | 50,000-250,000 | 2.34 × 10⁵ | <10 |
| 2 | Polyorganosiloxane | 556-67-2 | 2550-3570 | 3.74 × 10⁴ | <1 |
| 3 | Polyorganosiloxane | 556-67-2 | 300,000-750,000 | 5.8 × 10⁵ | <10 |

### Siloxane Comprising a Hydrophilic Group Component 4

A dicarboxylate polydimethylsiloxane was prepared as described in synthetic example 1 of EP3280496A1

### Component 5

### Potassium Salt of Dicarboxylate Polydimethylsiloxane

### Component 6

A 4-((2-(methacryloyloxy)-4-ethylcyclohexyl)oxy)-4-oxobutanoic acid functionalized polydimethylsiloxane was prepared as described in synthetic example 5 of WO2018/152392 A1

### Component 7

Silsoft™ BAPD fluid, an amino polydimethylsiloxane was used as component 7.

### Component 8

MQH-9, a MQ hydride (100 grams) was taken in a 500 mL three round bottom flask fitted with water condenser, thermopocket, and dropping funnel under N₂ sparging. The dropping funnel was filled with allyl succinic anhydride (CAS No. 7539-12-0) (72.2 g). The content of the round bottom flask was heated to 85° C., and 7.22 g of allyl succinic anhydride was charged in the round bottom flask. To this mixture, 10 ppm of Karstedt's catalyst (CAS No. 68478-92-2) was added followed by dropwise addition of the remaining allyl succinic anhydride in the dropping funnel. The reaction was allowed to proceed for 4 to 5 hours. Triisopropoxy(vinyl)silane (CAS No. 18023-33-1) (119.8 g) was then added to the dropping funnel and added to the round bottom flask dropwise, and the reaction was allowed to again proceed for 4 to 5 hours. After the reaction, the round bottom flask was cooled to 50° C. and was maintained under vacuum for 2 hours to obtain ionic MQ resin. ionic MQ resin was analyzed using GPC having a unimodal resin peak.

### Component 9

MQH-9, a MQ hydride (100 grams) was taken in a 500 mL three round bottom flask fitted with water condenser, thermopocket, and dropping funnel under N₂ sparging. The dropping funnel was filled with vinylcyclohexene oxide (CAS No. 106-86-5) (64.0 g). The content of round bottom flask was heated to 85° C., and 6.4 g of vinylcyclohexene oxide was charged in the round bottom flask. To this mixture, 10 ppm of Karstedt's catalyst (CAS No. 68478-92-2) was added followed by dropwise addition of the remaining vinylcyclohexene in the dropping funnel. The reaction was allowed to proceed for 4 to 5 hours. Triisopropoxy(vinyl)silane (CAS No. 18023-33-1) (119.8 g) was then added to the dropping funnel and added to the round bottom flask dropwise, and the reaction was allowed to again proceed for 4 to 5 hours. After the reaction, the round bottom flask was cooled to 50° C. and Jeffamine M-600 (CAS No. 83713-01-3) (300.93 g) was added, and the reaction was allowed to proceed for 24 hours. After 24 hours, the contents of the round bottom flaks were maintained under vacuum for 2 hours to obtain polyether functional MQ resin. Polyether functional MQ resin was analyzed using GPC having a unimodal resin peak.

### Component 10

Ethylene Glycol Monoallyl Ether (CAS No. 111-45-5) (100 g), N,N-Dimethylcarbamyl chloride (CAS No. 79-44-7) (115.83 g), and 4-(Dimethylamino)pyridine (CAS No. 1122-58-3) (5.98 g) were taken in a two neck round bottom flask fitted with a condenser and a thermopocket. The contents of the round bottom flask were heated to 80° C. and reaction was allowed to proceed for 24 hours to synthesize 2-allyloxyethyl N,N-dimethylcarbamate. The product was dissolved in hexane and washed with 1N HCl solution followed by 1 N sodium bicarbonate solution and brine. The organic layer was dried over anhydrous sodium sulfate, followed by removal of hexane using low pressure evaporation. 200 g of 2-allyloxyethyl N,N-dimethylcarbamate was obtained.

MQH-9, a MQ hydride (100 grams) was taken in a 1000 mL three round bottom flask fitted with water condenser, thermopocket, and dropping funnel under N₂ sparging. Dropping funnel was filled with 2-allyloxyethyl N,N-dimethylcarbamate (89.3 g). The content of the round bottom flask was heated to 85° C., and 8.9 g of 2-allyloxyethyl N,N-dimethylcarbamate was charged in the round bottom flask. To this mixture, 10 ppm of Karstedt's catalyst (CAS No. 68478-92-2) was added followed by dropwise addition of the remaining 2-allyloxyethyl N,N-dimethylcarbamate in the dropping funnel. The reaction was allowed to proceed for 4 to 5 hours. Triisopropoxy(vinyl)silane (CAS No. 18023-33-1) (119.8 g) was then added to the dropping funnel and added to the round bottom flask dropwise, and the reaction was allowed to again proceed for 4 to 5 hours. After the reaction, the round bottom flask was cooled to 50° C. Tetrahydrofuran (CAS No. 109-99-9) (300 mL) and chloroacetic acid (CAS No. 79-11-8) (48.7 g) were added to the round bottom flask, and the reaction was allowed to proceed for 24 hours. Tetrahydrofuran was removed under low pressure evaporation to obtain zwitterionic MQ resin. The zwitterionic MQ resin was analyzed using GPC having a unimodal resin peak.

### Preparation of Silicone PSA

### Example 1

The polyorganosiloxane of component 1 (52.07 grams) and component 2 (52.07 grams) were added followed by MQ3 (171.84 grams) or vice versa in a 3-liter planetary mixture equipped with helical blade & heating apparatus, thermocouple, sparge tube (for N₂ sparging). The reactor temperature was initially set to 125-130° C. under positive nitrogen flow. The above mixture was finally agitated at 135-145° C. until a completely homogeneous solution/dispersion was obtained. The mixing process was continued for 1-4 hours until the MQ resin was dissolved or dispersed completely in the polyorganosiloxane. 12 grams (4%) of component 4 of type R-Dₓ-R (where R=11-carboxy-1-undecyl, D=Me₂SiO and x=90) was added, and the reaction was then continued for another 7 hours. The reactor temperature was maintained at 145° C. under vacuum for 1 to 2 hours. After the cooking step, the reactor was cooled. The solids content was then adjusted to 60% by dissolving the resulting high viscous mass in 40 parts ethyl acetate (˜200 grams) at 50° C. The PSA viscosity was 1904 cP at 25° C. and had a GPC with multimodal resin and polymer peaks.

### Example 2

The polyorganosiloxane of component 2 (104 grams) was added followed by MQ3 (171.0 grams) or vice versa in a 3-liter planetary mixture equipped with helical blade & heating apparatus, thermocouple, sparge tube (for N2 sparging). The reactor temperature was initially set to 125-130° C. under positive nitrogen flow. Finally, the above mixture was agitated at 135-145° C. until a completely homogeneous solution/dispersion was obtained. The mixing process was continued for 1-4 hours until the MQ resin was dissolved or dispersed completely in the gum mixture. 24 grams (8%) of component 4 was added, and the reaction continued for another 7 hours. The reactor temperature was maintained at 145° C. under vacuum for 1 to 2 hours. After the cooking step, the reactor was cooled. The solids content was then adjusted to 60% by dissolving the resulting high viscous mass in 40 parts ethyl acetate (˜200 grams) at 50° C. The PSA viscosity was 460 cP at 25° C. and had a GPC with multimodal resin and polymer peaks.

### Example 3

The polyorganosiloxane of component 1 (52.07 grams) and component 2 (52.07 grams) were added followed by MQ3 (171.84 grams) or vice versa in a 3-liter planetary mixture equipped with helical blade & heating apparatus, thermocouple, sparge tube (for N₂ sparging). The reactor temperature was initially set to 125-130° C. under positive nitrogen flow. The above mixture was finally agitated at 135-145° C. until a completely homogeneous solution/dispersion was obtained. The mixing process was continued for 1-4 hours until the MQ resin was dissolved or dispersed completely in the polyorganosiloxane. 24 grams (8%) of component 4 was added and reaction continued for another 7 hours. The reactor temperature was then maintained at 145° C. under vacuum for 1 hour. After the cooking step, the reactor was cooled. The solids content was then adjusted to 60% by dissolving the resulting high viscous mass in 40 parts ethyl acetate (˜200 grams) at 50° C. The PSA viscosity was 1200 cP at 25° C. and had a GPC with multimodal resin and polymer peaks.

### Example 4

The polyorganosiloxane of component 2 (52.07 grams) and component 3 (52.07 grams) were added followed by MQ3 (171.84 grams) or vice versa in a 3-liter planetary mixture equipped with helical blade & heating apparatus, thermocouple, sparge tube (for N₂ sparging). The reactor temperature was initially set to 125-130° C. under positive nitrogen flow. The above mixture was agitated at 135-145° C. until a completely homogeneous solution/dispersion was obtained. The mixing process was continued for 1-4 hours until the MQ resin was dissolved or dispersed completely in the polyorganosiloxane. 24 grams (8%) of component 4 was added and reaction continued for another 7 hours. The reactor temperature was maintained at 145° C. under vacuum for 2 hours. After the cooking step, the reactor was cooled. The solids content was then adjusted to 60% by dissolving the resulting high viscous mass in 40 parts ethyl acetate (˜200 grams) at 50° C. The PSA viscosity was 1200 cP at 25° C. and had a GPC with multimodal resin and polymer peaks.

### Example 5

The polyorganosiloxane of component 2 (115.2 grams) was added followed by MQ3 (172.8 grams) or vice versa in a 3-liter planetary mixture equipped with helical blade & heating apparatus, thermocouple, sparge tube (for N₂ sparging). The reactor temperature was initially set to 125-130° C. under positive nitrogen flow. The above mixture was agitated at 135-145° C. until a completely homogeneous solution/dispersion was obtained. The mixing process was continued for 1-4 hours until the MQ resin was dissolved or dispersed completely in the polyorganosiloxane. 12 grams (4%) of component 5 was added and reaction continued for another 7 hours. The reactor temperature was maintained at 145° C. under vacuum for 2 hours. After the cooking step, the reactor was cooled. The solids content was then adjusted to 60% by dissolving the resulting high viscous mass in 40 parts ethyl acetate (˜200 grams) at 50° C. The PSA viscosity was 408 cP at 25° C. and had a GPC with multimodal resin and polymer peaks.

### Example 6

The polyorganosiloxane of component 2 (115.2 grams) was added followed by MQ3 (172.8 grams) or vice versa in a 3-liter planetary mixture equipped with helical blade & heating apparatus, thermocouple, sparge tube (for N₂ sparging). The reactor temperature was initially set to 125-130° C. under positive nitrogen flow. Finally, the above mixture was agitated at 135-145° C. until a completely homogeneous solution/dispersion was obtained. The mixing process was continued for 1-4 hours until the MQ resin was dissolved or dispersed completely in the polyorganosiloxane. 12 grams (4%) of component 6 was added and reaction continued for another 7 hours. The reactor temperature was maintained at 145° C. under vacuum for 2 hours. After the cooking step, the reactor was cooled. The solids content was then adjusted to 60% by dissolving the resulting high viscous mass in 40 parts ethyl acetate (˜200 grams) at 50° C. The PSA viscosity was 330 cP at 25° C. and had a GPC with multimodal resin and polymer peaks. Mention radical catalyst for acrylate polymerization.

### Example 7

The polyorganosiloxane of component 2 (36 grams) was added followed by MQ4 (54 grams) or vice versa in a 3-liter planetary mixture equipped with helical blade & heating apparatus, thermocouple, sparge tube (for N₂ sparging). The reactor temperature was initially set to 125-130° C. under positive nitrogen flow. The above mixture was finally agitated at 135-145° C. until a completely homogeneous solution/dispersion was obtained. The mixing process was continued for 1-4 hours until the MQ resin was dissolved or dispersed completely in the polyorganosiloxane. 3.6 grams (4%) of component 7 was added and reaction continued for another 12 hours. The reactor temperature was maintained at 145° C. under vacuum for 2 hours. After the cooking step, the reactor was cooled. The solids content was then adjusted to 60% by dissolving the resulting high viscous mass in 40 parts ethyl acetate (˜60 grams) at 50° C. The PSA viscosity was 256 cP at 25° C. and had a GPC with multimodal resin and polymer peaks.

### Example 8

Component 2 (18 grams) and component 3 (18 grams) followed by MQ4 (54 grams) in heptane (36 grams) were added in a glass reactor equipped with a helical blade, heating apparatus, thermocouple, and sparge tube (for N₂ sparging) and a Dean Stark water trap filled with heptane. The mixture was homogeneously mixed at 90° C. for 3 hours under positive nitrogen flow. 3.6 grams (4%) of component 4 was added and reaction continued for 12 hours. The temperature of the reaction was increased to 110° C. and the mixture refluxed until the last trace of water was observed. The PSA obtained was obtained in heptane solution. The PSA viscosity was 162 cP at 25° C. and had a GPC with multimodal resin and polymer peaks.

### Example 9

The polyorganosiloxane of component 1 (16.98 grams) and component 2 (16.98 grams) were added followed by MQ4 (53.79 grams) or vice versa in a grass reactor equipped with helical blade & heating apparatus, thermocouple, sparge tube (for N₂ sparging). The reactor temperature was initially set to 125-130° C. under positive nitrogen flow. The mixing process was continued overnight until the MQ resin was dissolved or dispersed completely in the polyorganosiloxane. 2.25 grams component 8 was added, and reaction was continued for another 12 hours. After the cooking step, the reactor was cooled. The solids content was then adjusted to 60% by dissolving the resulting high viscous mass in 40 parts ethyl acetate (˜60 grams) at 50° C. The PSA viscosity was 461 cP at 25° C. and had a GPC with multimodal resin and polymer peaks.

### Example 10

The polyorganosiloxane of component 2 (38.30 grams) was added followed by MQ4 (49.45 grams) or vice versa in a grass reactor equipped with helical blade & heating apparatus, thermocouple, sparge tube (for N₂ sparging). The reactor temperature was set to 125-130° C. under positive nitrogen flow. The mixing process was continued overnight until the MQ resin was dissolved or dispersed completely in the polyorganosiloxane. 2.25 grams (2.5%) component 9 was added, and reaction was continued for another 7 hours. After the cooking step, the reactor was cooled. The solids content was then adjusted to 60% by dissolving the resulting high viscous mass in 40 parts ethyl acetate (˜60 grams) at 50° C. The PSA viscosity was 365 cP at 25° C. and had a GPC with multimodal resin and polymer peaks.

### Example 11

The polyorganosiloxane of component 1 (16.98 grams) and component 2 (16.98 grams) were added followed by MQ4 (53.79 grams) or vice versa in a grass reactor equipped with helical blade & heating apparatus, thermocouple, sparge tube (for N₂ sparging). The reactor temperature was set to 125-130° C. under positive nitrogen flow. The mixing process was continued overnight until the MQ resin was dissolved or dispersed completely in the polyorganosiloxane. 2.25 grams (2.5%) component 10 was added, and reaction was continued for another 7 hours. The reactor temperature was maintained at 145° C. under vacuum conditions. After the cooking step, the reactor was cooled. The solids content was then adjusted to 60% by dissolving the resulting high viscous mass in 40 parts ethyl acetate (˜60 grams) at 50° C. The PSA viscosity was 556 cP at 25° C. and had a GPC with multimodal resin and polymer peaks.

### Comparative Example 1

The polyorganosiloxane of component 2 (127.34 grams) was added followed by MQ3 (172.65 grams) or vice versa in a 3-liter planetary mixture equipped with helical blade & heating apparatus, thermocouple, sparge tube (for N₂ sparging). The reactor temperature was set to 125-130° C. under positive nitrogen flow. The above mixture was agitated at 125-130° C. until a completely homogeneous solution/dispersion was obtained. The mixing process was continued for 1-4 hours until the MQ resin was dissolved or dispersed completely in the polyorganosiloxane. 2.0 grams of 2,4,6-Trimethyl-2,4,6-trivinylcyclotrisilazane (CAS-No:5505-72-6) was added and reaction continued for another 3 hrs. Finally, the reactor temperature was increased to 150° C. and hold the temperature for 2-3 hours under N₂. After the cooking step, the reactor was cooled. The solids content was then adjusted to 60% by dissolving the resulting high viscous mass in 40 parts ethyl acetate (˜200 grams) at 50° C. The PSA viscosity was 1664 cP at 25° C. and had a GPC with multimodal resin and polymer peaks.

### Comparative Example 2

The polyorganosiloxane of component 1 (287.23 grams) and component 3 (95.74 grams) were added followed by MQ3 (517.02 grams) or vice versa in a 3-liter planetary mixture equipped with a helical blade, heating apparatus, thermocouple, and sparge tube (for N₂ sparging). The reactor temperature was set to 125-130° C. under positive nitrogen flow. The above mixture was agitated at 125-130° C. until a completely homogeneous solution/dispersion was obtained. The mixing process was continued for 1-4 hours until the MQ resin was dissolved or dispersed completely in the polyorganosiloxane. 7.5 grams of Tetramethylammonium siloxanolate (CAS-No. 68440-88-0) was added, and the reaction continued for another 3 hours. Finally, the reactor temperature was increased to 150° C. and held there for 2-3 hours under N₂. After this step, the reactor was cooled. The solids content was then adjusted to 60% by dissolving the resulting high viscous mass in 40 parts heptane (˜600 grams) at 50° C. The PSA viscosity was 15900 cP at 25° C. and had a GPC with multimodal resin and polymer peaks.

### Comparative Example 3

The polyorganosiloxane of component 2 (18 grams) and component 3 (18 grams) were added followed by MQ4 (54 grams) or vice versa in a 3-liter planetary mixture equipped with helical blade & heating apparatus, thermocouple, sparge tube (for N₂ sparging). The reactor temperature was set to 125-130° C. under positive nitrogen flow. The above mixture was agitated at 125-130° C. until a completely homogeneous solution/dispersion was obtained. The mixing process was continued for 1-4 hours until the MQ resin was dissolved or dispersed completely in the polyorganosiloxane. 0.45 grams (0.5%) of Acetic Acid (CAS-No. 64-19-7) was added, and the reaction continued for another 7 hours. The neutralization step was performed at 70° C. using 1% lithium hydroxide in ethanol. After this step, the reactor was cooled. The solids content was then adjusted to 60% by dissolving the resulting high viscous mass in 40 parts heptane (˜600 grams) at 50° C. The PSA viscosity was 406 cP at 25° C. and had a GPC with multimodal resin and polymer peaks.

### Comparative Example 4

A solution of component 1 (76.59 grams) and component 3 (25.53 grams) with 60% MQ3 in heptane (229.78 g) were added in a 1-liter planetary mixture equipped with a helical blade, heating apparatus, thermocouple, and sparge tube (for N₂ sparging) and a Dean Stark water trap filled with heptane and 68.1 grams heptane was added. The mixture was homogeneously mixed at 90° C. for 3 hours under positive nitrogen flow. 1.5 grams of 1% lithium hydroxide solution was added and reaction continued for 3 hours. The temperature of the reaction was increased to 110° C. and the mixture refluxed until the last trace of water was observed. The neutralization step was performed at 70° C. using 1% phosphoric acid in IPA. Finally, the heptane solvent was removed using rotary evaporator and then dissolve it again in ethyl acetate. The PSA viscosity was 9700 cP at 25° C. in ethyl acetate and had a GPC with multimodal resin and polymer peaks.

### Silanol Content Estimation

The silanol content was determined using ²⁹Si Nuclear Magnetic Resonance technique.

### Experimental Method:

The sample was prepared by adding ˜2 g of sample to 3 mL CDCl₃. 30 mg of Cr(acac)₃ was added as relaxation agent. 2.5 mL of sample solution was transferred to 10 mm Teflon tube and ²⁹Si spectrum was acquired. Integration of all peaks in NMR spectrum gave mol % which was converted to wt % by multiplying with repeat unit weight for corresponding species. Sample was analyzed by quantitative ²⁹Si NMR spectroscopy on Bruker 400 MHz NMR.
Experimental parameters:
System: Bruker 400 MHz
Probe: 10 mm ²⁹Si probe
Pulse Program: ZGIG45
Recycle Delay: 5 seconds
Decoupling Method: Inverse Gated
Decoupling Sequence: WALTZ 16
Number of Scans: 9472

### Viscosity Measurements of the PSA Samples

PSA samples swelled in ethyl acetate were made with 60% solids. The solution viscosity of the material was determined at 25° C. with a Brookfield (DV1) Viscometer using spindle #4c

TABLE 2
Summary of PSA Examples

| | | | | Siloxane | |
|---|---|---|---|---|---|
| | | | | comprising a | |
| | | Functional | | hydrophilic | |
| PSA | Resin | Resin | Polyorganosiloxane | group | Catalyst |
| Example 1 | MQ | NA | Component 1 and | Component 4 | NA |
| | silicone | | Component 2 | | |
| | resin | | | | |
| Example 2 | MQ | NA | Component 2 | Component 4 | NA |
| | silicone | | | | |
| | resin | | | | |
| Example 3 | MQ | NA | Component 1 and | Component 4 | NA |
| | silicone | | Component 2 | | |
| | resin | | | | |
| Example 4 | MQ | NA | Component 2 and | Component 4 | NA |
| | silicone | | Component 3 | | |
| | resin | | | | |
| Example 5 | MQ | NA | Component 2 | Component 5 | NA |
| | silicone | | | | |
| | resin | | | | |
| Example 6 | MQ | NA | Component 2 | Component 6 | NA |
| | silicone | | | | |
| | resin | | | | |
| Example 7 | MQ | NA | Component 2 | Component 7 | NA |
| | silicone | | | | |
| | resin | | | | |
| Example 8 | MQ | NA | Component 2 and | Component 4 | NA |
| | silicone | | Component 3 | (Solution | |
| | resin | | | Processed) | |
| Example 9 | MQ | Component 8 | Component 1 and | NA | NA |
| | silicone | | Component 2 | | |
| | resin | | | | |
| Example 10 | MQ | Component 9 | Component 2 | NA | NA |
| | silicone | | | | |
| | resin | | | | |
| Example 11 | MQ | Component 10 | Component 1 and | NA | NA |
| | silicone | | Component 2 | | |
| | resin | | | | |
| Comparative | MQ | NA | Component 2 | NA | 2,4,6-Trimethyl-2,4,6- |
| Example 1 | silicone | | | | trivinylcyclotrisilazane |
| | resin | | | | |
| Comparative | MQ | NA | Component 1 and | NA | Tetramethylammonium |
| Example 2 | silicone | | Component 3 | | siloxanolate |
| | resin | | | | |
| Comparative | MQ | NA | Component 2 and | NA | Acetic Acid |
| Example 3 | silicone | | Component 3 | | |
| | resin | | | | |
| Comparative | MQ | NA | Component 1 and | NA | LiOH |
| Example 4 | silicone | | Component 3 | | |
| | resin | | | | |

| | | | % Reduction | Viscosity |
|---|---|---|---|---|
| | Functional | | in Residual | in 60 wt. % |
| | Component | | Silanol after | solution |
| | concentration | R/G | condensation | in diluent |
| PSA | (wt %) | ratio | by ²⁹Si NMR | (cps) |
| Example 1 | 4% | 1.65 | 48.73 | 1904 |
| Example 2 | 8% | 1.65 | 31.14 | 460 |
| Example 3 | 8% | 1.65 | 34.80 | 1200 |
| Example 4 | 8% | 1.65 | — | 536 |
| Example 5 | 4% | 1.5 | 85.80 | 408 |
| Example 6 | 4% | 1.5 | 53.75 | 330 |
| Example 7 | 4% | 1.5 | — | 256 |
| Example 8 | 4% | 1.5 | — | 162 |
| Example 9 | 2.5% | 1.65 | 58.67 | 461 |
| Example 10 | 2.5% | 1.35 | 52.86 | 365 |
| Example 11 | 2.5% | 1.65 | 74.47 | 556 |
| Comparative | 0% | 1.35 | 73.36 | 1664 |
| Example 1 | | | | |
| Comparative | 0% | 1.35 | 78.36 | 15900 |
| Example 2 | | | | |
| Comparative | 0% | 1.5 | — | 406 |
| Example 3 | | | | |
| Comparative | 0% | 1.35 | 81.20 | 9700 |
| Example 4 | | | | |

### Testing of the PSA Samples

PSA sample was coated to a thickness of 70-80 micron for probe tack and peel strength adhesion measurements. The adhesives were coated on 3M Scotchpak™ 9733 backing polyester film laminate and using 3M Scotchpak™ 1022 release liner. Adhesives were dried for 10 minutes at 90° C. in oven. Tack testing was done as per FINAT FTM 9 for measuring tack with units of grams. Peel adhesion testing was done per ASTM D3330/D3330M measuring adhesion to mirrored stainless steel plates at 180′ peel angle. Peel adhesion results were recorded for 1-inch strips as N/in peel force from stainless steel panels at 12 ipm peel speed.

TABLE 3
Adhesive performance

| | Probe Tack | Peel strength |
|---|---|---|
| PSA | Adhesive Force (N) | Adhesive strength (N/mm) |
| Example 2 | 6.95 | 15.59 |
| Example 3 | 4.79 | 11.62 |
| Example 10 | 5.89 | 10.77 |
| Example 11 | 2.69 | 8.2 |
| Comparative | 2.17 | 28.99 |
| Example 1 | | |

### Cyclic Siloxane Estimation

Cyclic siloxane present in PSA were quantified using gas chromatographic method. Sample was extracted for 24 hours as described below.

### Experimental Method:

Approximately 0.5 g sample was weighed in 20 mL vial. Accurate weight was noted down. Sample was extracted for 24 hours in 10 mL working solution prepared using acetone as solvent and toluene and dodecane as internal standards (0.05 mg/mL). Calibration plots for cyclic siloxanes D4, D5 and D6 were generated by preparing various standards of concentration varying from 0.005 to 0.1 mg/mL in acetone. Peak area was normalized by dividing with peak area for dodecane and plotted against concentration. Cyclic siloxanes present in the sample were calculated using normalized peak area in GC chromatogram of sample and the calibration curve.

### GC Conditions

Instrument: Agilent 7890A GC
Detector: FID at 350° C.; H2: 30 mL/min, Air: 300 mL/min, makeup flow: 25.4 mL/min
Sample Introduction: Split Injection/225° C./50:1 split ratio
Injection Volume: 2 μL (Agilent 7693 Autosampler)
Carrier Gas: Nitrogen (1.4 mL/min, constant flow mode)
Capillary Column: Agilent HP-5 (30 m×0.32 mm×0.25 m)
Temperature Program: 50° C. (5 min) to 200° C. at 15° C./min then to 315° C. (20 min)

TABLE 4
Cyclic siloxanes estimation

| | Cyclic siloxane content (ppm) | | |
|---|---|---|---|
| PSA | D4 | D5 | D6 |
| Example 1 | <100 | <100 | <100 |
| Example 2 | <100 | <100 | <100 |
| Example 3 | <100 | <100 | <100 |
| Example 4 | <100 | <100 | <100 |
| Example 5 | <100 | <100 | <100 |
| Example 6 | <100 | <100 | <100 |
| Example 7 | <100 | <100 | <100 |
| Example 8 | 233 | <100 | <100 |
| Example 9 | ND* | ND* | ND* |
| Example 10 | ND* | <100 | <100 |
| Example 11 | ND* | <100 | 115 |
| Comparative Example 1 | <100 | <100 | <100 |
| Comparative Example 2 | <100 | <100 | <100 |
| Comparative Example 4 | 7233 | 6158 | 2536 |

*ND: Not detected

### Viscoelastic Properties

The viscoelastic properties of the silicone PSA made by the described process herein, has been thoroughly characterized by the dynamic rheological analysis. The G′ at lower angular frequency (ω=0.01 rad/s) represents the adhesive strength during application of the adhesive whereas the G′ at higher angular frequency (ω=100 rad/s) relates to the peel force at debonding. The complex viscosity values on the other hand compares the cold flow properties of these adhesives. The data presented in the table-5 suggests that for all the given compositions [example-1 to 11], the PSA properties are comparable to those where the known state of the art condensation catalyst were used. The experimental process involves casting of PSA onto a suitable release liner and drying at 150° C. for 1 hour and then transferring from release linear to the DHR3 rheometer (TA Instruments). A 25 mm parallel plate geometry were used in oscillation mode with an angular strain of 0.01% to generate the rheograms.

TABLE 5
Rheology

| | | | G′ | G″ | | G′ | G″ |
|---|---|---|---|---|---|---|---|
| | | | [dyne/cm²] | [dyne/cm²] | [η*] (P) | [dyne/cm²] | [dyne/cm²] |
| | R/G | Tg | ω = 0.01 rad/s | ω = 0.01 rad/s | ω = 0.01 rad/s | ω = 100 rad/s | ω = 100 rad/s |
| PSA | ratio | [° C.] | (T = 30° C.) | (T = 30° C.) | (T = 30° C.) | (T = 30° C.) | (T = 30° C.) |
| Example 1 | 1.65 | 61 | 5.5 × 10⁴ | 12.8 × 10⁴ | 1.4 × 10⁷ | 1.65 × 10⁷ | 1.0 × 10⁷ |
| Example 2 | 1.65 | 45 | 1.47 × 10⁴ | 3.18 × 10⁴ | 3.5 × 10⁶ | 9.38 × 10⁶ | 8.99 × 10⁶ |
| Example 3 | 1.65 | 52.9 | 2.58 × 10⁴ | 1.26 × 10⁵ | 1.29 × 10⁷ | 1.92 × 10⁷ | 1.43 × 10⁷ |
| Example 4 | 1.65 | 41 | 6.58 × 10³ | 1.78 × 10⁴ | 1.9 × 10⁶ | 4.8 × 10⁶ | 5.25 × 10⁶ |
| Example 5 | 1.5 | 41.7 | 1.7 × 10³ | 6.1 × 10³ | 6.35 × 10⁵ | 2.69 × 10⁶ | 4.47 × 10⁶ |
| Example 6 | 1.5 | 32 | 1.52 × 10⁴ | 1.73 × 10⁴ | 2.19 × 10⁶ | 4 × 10⁶ | 5 × 10⁶ |
| Example 7 | 1.5 | — | 3.12 × 10⁴ | 3.78 × 10⁴ | 4.39 × 10⁶ | 5.9 × 10⁶ | 6.26 × 10⁶ |
| Example 8 | 1.5 | 35.9 | 1.95 × 10⁴ | 1.95 × 10⁴ | 2.43 × 10⁶ | 7.88 × 10⁶ | 6.66 × 10⁶ |
| Example 9 | 1.65 | 55.5 | 8.27 × 10⁴ | 2.2 × 10⁵ | 2.39 × 10⁷ | 2.18 × 10⁷ | 1.16 × 10⁷ |
| Example 10 | 1.35 | 44 | 5.26 × 10⁴ | 6.1 × 10⁴ | 8.0 × 10⁶ | 7.56 × 10⁶ | 5.28 × 10⁶ |
| Example 11 | 1.65 | 64.7 | 4.59 × 10⁵ | 7.16 × 10⁵ | 8.5 × 10⁷ | 2.8 × 10⁷ | 1.16 × 10⁷ |
| CE- 1 | 1.35 | 82 | 3.41 × 10⁴ | 8.14 × 10⁴ | 6.27 × 10⁶ | 1.57 × 10⁷ | 1.09 × 10⁷ |
| CE- 2 | 1.35 | — | 3.45 × 10⁵ | 5.34 × 10⁵ | 6.36 × 10⁷ | 3.85 × 10⁷ | 1.92 × 10⁷ |
| CE-3 | 1.5 | 50.4 | 7.74 × 10⁴ | 1.41 × 10⁵ | 1.6 × 10⁷ | 1.72 × 10⁷ | 1.0 × 10⁷ |
| CE-4 | 1.35 | — | 2.8 × 10⁴ | 5.55 × 10⁴ | 6.22 × 10⁶ | 1.33 × 10⁷ | 1.05 × 10⁷ |

### Shelf Life

Examples and comparative examples were stored at room temperature for one year without filtration after their synthesis and were monitored for the precipitation in the sample.

TABLE 6
Precipitation in PSA samples after storage

| Example | Precipitation |
|---|---|
| Comparative Example 4 | Yes |
| Example 1 | No |
| Example 2 | No |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a silicone composition, adhesives formed from such compositions, and articles employing such compositions or adhesives. Modifications may occur to those skilled in the art and to those who may make and use the invention. The disclosed embodiments are merely for illustrative purposes and not intended to limit the scope of the invention or the subject matter set forth in the claims.

The invention claimed is:

1. A process for producing a pressure sensitive adhesive comprising:
reacting (i) a MQ silicone resin, (ii) a polyorganosiloxane, and (iii) a siloxane comprising a hydrophilic group, wherein the reaction is conducted in the absence of an external catalyst.

2. The process of claim 1, wherein the hydrophilic functional group selected from an ionic group, an ionizable group, a zwitterionic group, or a combination of two or more thereof.

3. The process of claim 1, wherein the siloxane comprising a hydrophilic group (iii) is selected from a compound of the formula:
M¹ₐM²_{b}M³_{c}D¹_{d}D²ₑD³_{f}T¹_{g}T²ₕT³ᵢQ¹ⱼQ²ₖQ³ₗQ⁴ₒQ⁵ₚ
where
M¹=R⁵R⁶R⁷SiO_{1/2}
M²=R⁸R⁹R¹⁰SiO_{1/2}
M³=R¹¹R¹²R¹³SiO_{1/2}
D¹=R¹⁴R¹⁵SiO_{2/2}
D²=R¹⁶R¹⁷SiO_{2/2}
D³=R¹⁸R¹⁹SiO_{2/2}
T¹=R²⁰SiO_{3/2}
T²=R²¹SiO_{3/2}
T³=R²²SiO_{3/2}
Q¹=Si(OR²³)₁O_{3/2}
Q²=Si(OR²⁴)₂O_{2/2}
Q³=Si(OR²⁵)₃O_{1/2}
Q⁴=Si(OR²⁶)₄
Q⁵=SiO_{4/2}
where:
a, b, c, d, e, f, g, h, i, j, k, 1, o, and p are zero or any positive integer subject to the following limitations:
$$1 \leq [ a + b + c + d + e + f + g + h + i + j + k + l + o + p ] \leq 6 \; 000 ; \\ [ b + e + h + k ] \geq 1 ;$$
R⁵, R⁶, R⁷, R⁹, R¹⁰, R¹², R¹³, R¹⁴, R¹⁵, R¹⁷, R¹⁹, and R²⁰ are each independently selected from hydrogen, a C1-C60 alkyl, a C6-C60 aromatic containing group, a C1-C10 alkoxy, and a hydroxyl;
R⁸, R¹⁶, R²¹, and R²⁴ are each independently selected from a monovalent hydrophilic group of the formula, where G≥0. 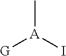
where A is a bridging unit between the siloxane moiety and the hydrophilic group I, having at least one spacing atom selected from a C1-C60 acyclic hydrocarbon radical, a C4-C60 alicylic radical, an C6-C60 aromatic hydrocarbon radical, a polyetheramine, a polyether, a polyamide, a polyester, a polyurethane, a polysulfone, a polycarbonate, or a combination of two or more thereof, where the bridging unit may include one or more moieties selected from alkoxy, carboxy, urethane, urea, ketone, or a combination of two or more thereof; I is an ionic group, an ionizable group, a zwitterionic group, or a polar hydrophilic group or moieties including but not limited to a polyetheramine, a polyether, a polyamide, a polyester, a polyurethane, a polysulfone, or a polycarbonate;
G is a polymerizable group having the general Formula: 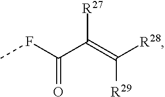
or
a non-polymerizable group of formula — —F-K, wherein F is a linker group chosen from a C1-C60 acyclic hydrocarbon radical, a C4-C60 alicylic radical, an C6-C60 aromatic hydrocarbon radical, a polyetheramine, a polyether, a polyamide, a polyester, a polyurethane, a polysulfone, a polycarbonate, or a combination of two or more thereof, where the bridging unit may include one or more moieties selected from alkoxy, carboxy, urethane, urea, ketone, or a combination of two or more thereof,
R²⁷, R²¹, and R²⁹ are independently chosen from hydrogen or monovalent hydrocarbon radical with 1-5 carbon atoms, and
K is independently chosen from hydrogen, a C1-C60 acyclic hydrocarbon radical, a C4-C60 alicylic radical, an C6-C60 aromatic hydrocarbon radical, an epoxy, or an ether group;
R¹¹, R¹⁸, R²² are each independently selected from the group -A-G where A and G are as described above; and
R²³, R²⁵, and R²⁶ can be independently selected from R⁵ to R²² or a combination of thereof.

4. The process of claim 3, wherein the siloxane comprising a hydrophilic group is of the formula M¹ₐM²_{b}M³ₑQ⁵ₚ, where b is ≥1.

5. The process of claim 3, wherein I is selected from a carboxylate —COO⁻, a dicarboxylate (—R(COO—)₂) a sulfone —SO₂—, a sulfonate —SO₃⁻, a sulfate —OSO₃⁻, a phosphonate —PO₃²⁻, a phosphate —OPO₃²⁻ group, —NR³⁰R³¹H, —NH₂R³², —NH₃, or an ammonium salt, each containing a hydrogen or a cation independently selected from an alkali metal, an alkali earth metal, a transition metal, a quaternary ammonium group, and a phosphonium group, where R³⁰, R³¹, and R³² are independently selected from a C1-C30 hydrocarbon

6. The process of claim 3, wherein I is selected from a group having the formula —R³³—N⁺(R³⁴)₂—R³⁵—I^{z}, where R³³ is a divalent hydrocarbon group having from 1 to 20 carbon atoms, R³⁴ is a monovalent hydrocarbon group having from 1 to 20 carbon atoms, R³⁵ is a divalent hydrocarbon group having from 2 to 20 carbon atoms; and I^{z} is an ionic group selected from a carboxylate —COO⁻, a sulfone —SO₂—, a sulfonate —SO₃⁻, a sulfate —OSO₃⁻, a phosphonate —PO₃²⁻, and a phosphate —OPO₃²⁻ group.

7. The process of claim 3, wherein I is a polar group selected from a polyetheramine, a polyether, a polyamide, a polyester, a polyurethane, a polysulfone, and/or a polycarbonate

8. The process of claim 3, wherein the hydrophilic group is a polyetheramine group selected from a compound of the formula:
R³⁶—(O—R³⁷—)_{q}—NH₂
where R³⁶ is selected from a C1-C60 hydrocarbon, R³⁷ is selected from a C1-C60 hydrocarbon, and q is ≥1.

9. The process of claim 8, wherein the polyetheramine is selected from a compound of the formula:
R³⁶—(O—CH₂CH₂)ₓ—(O—C CH₂CH₂CH₂)_{y}—(O CH₂CH₂CH(CH₃))_{z}—NH₂
and x, y, and z are independently 0 to about 300, where x+y+z is ≥2.

10. The process of claim 3, wherein the polyetheramine group is selected by the following general formula:

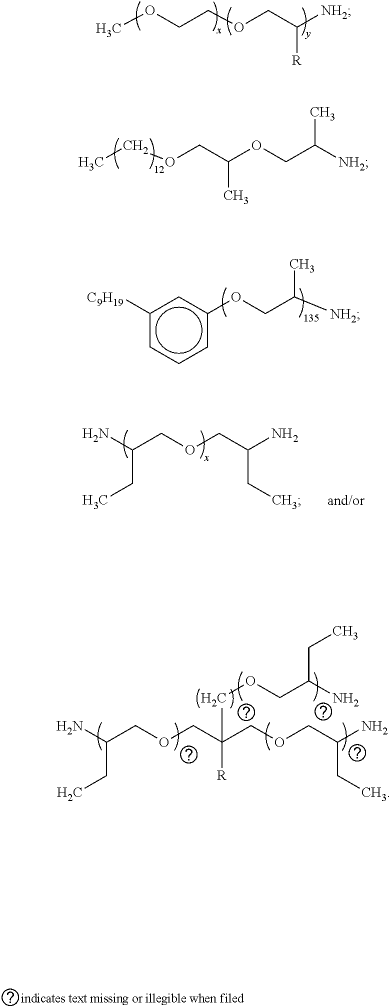

11. The process of claim 1, wherein the siloxane comprising a hydrophilic group (iii) is present in an amount of from about 0.1 wt. % to about 20 wt. % based on the total weight of the composition.

12. The process of claim 1, wherein the siloxane comprising a hydrophilic group (iii) is present in an amount of from about 1.5 wt. % to about 8 wt. % based on the total weight of the composition.

13. The process of claim 1, wherein reacting (i), (ii), and (iii) comprises forming a first mixture of (i) and (ii) and subsequently adding (iii) to the mixture of (i) and (ii).

14. The process of claim 2, wherein forming the first mixture of (i) and (ii) comprises dispersing the MQ silicone (i) in the polyorganosiloxane (ii), and heating the first mixture at temperature of from about 80 to about 150° C.

15. The process of claim 1, wherein reacting (i), (ii), and (iii) is carried out at a temperature of from about 80 to about 150° C.

16. The process of claim 1 comprising removing water from the product obtained from the process to provide a solid mass.

17. The process of claim 16 comprising dissolving the solid mass in a solvent to provide the final pressure sensitive adhesive composition.

18. A pressure sensitive adhesive composition obtained from the process of claim 1.

19. The pressure sensitive adhesive composition of claim 18, wherein the adhesive has a less than 2500 ppm of one or more of octamethylcyclotetrasiloxane, decamethylcyclopentasiloxane, and/or dodecamethylcyclohexasiloxane.

20. The pressure sensitive adhesive composition of claim 18, wherein the adhesive has a less than 1000 ppm of one or more of octamethylcyclotetrasiloxane, decamethylcyclopentasiloxane, and/or dodecamethylcyclohexasiloxane.

21. The pressure sensitive adhesive composition of claim 18, wherein the adhesive has a less than 500 ppm of one or more of octamethylcyclotetrasiloxane, decamethylcyclopentasiloxane, and/or dodecamethylcyclohexasiloxane.

22. The pressure sensitive adhesive composition of claim 18, wherein the adhesive has a less than 100 ppm of one or more of octamethylcyclotetrasiloxane, decamethylcyclopentasiloxane, and/or dodecamethylcyclohexasiloxane.

23. The pressure sensitive adhesive composition of claim 18, wherein the pressure sensitive adhesive does not exhibit precipitation after storage at room temperature for one year.
